(19) United States
(12) Patent Application Publication
(10) Pub. No.: US 2014/0347411 A1
(43) Pub. Date: Nov. 27, 2014

(54) DRIVING METHOD FOR DISPLAY

(71) Applicant: HannStar Display Corp., New Taipei City (TW)

(72) Inventors: Heng-Cheng TSENG, Chiayi County (TW); Ra-Bin LI, Tainan City (TW); Mu-Kai KANG, Pingtung City (TW)

(21) Appl. No.: 14/455,216

(22) Filed: Aug. 8, 2014

Related U.S. Application Data
(62) Division of application No. 13/234,553, filed on Sep. 16, 2011.

(30) Foreign Application Priority Data
Oct. 22, 2010 (TW) 099136013

(51) Int. Cl. G09G 3/36

(52) U.S. Cl. CPC G09G 3/3611
USPC 345/697

(57) ABSTRACT

There is provided a driving method for a display, which includes a display unit and a phase modulation unit. The display unit includes a plurality of pixel rows and generates image signals having a polarization direction. The phase modulation unit includes two oppositely disposed electrodes and an LC layer sandwiched between the two electrodes. The driving method changes a potential difference provided on the two electrodes of the phase modulation unit to control the twist of the LC layer thereby changing the polarization direction of the image signals generated by the display unit and passing through the phase modulation unit.

### CROSS REFERENCE TO RELATED APPLICATION

This application is a divisional of U.S. application Ser. No. 13/234,553, filed Sep. 16, 2011, and claims the priority benefit of Taiwan Patent Application Serial Number 099136013, filed on Oct. 22, 2010, the full disclosure of which is incorporated herein by reference.

### BACKGROUND

1. Field of the Invention

This invention generally relates to a display device and, more particularly, to a driving method for a 3D image display.

2. Description of the Related Art

With the maturity of the liquid crystal display, an image display capable of displaying 3D images becomes a next-generation display technology.

For example FIG. 1 shows a solid diagram of a conventional 3D image display, which includes a display unit 8 and a phase modulation unit 9. The image signals generated by the display unit 8 are modulated by the phase modulation unit 9 and then become left-eye image signals and right-eye image signals having perpendicular polarization directions at different time intervals. A user can see 3D images only by using conventional polarized glasses.

The display unit 8 includes an upper polarizer 81 and a lower polarizer 82 disposed oppositely, and the image signals ejecting from the upper polarizer 81 can have a polarization direction. The phase modulation unit 9 includes an upper transparent layer 91, a lower transparent layer 92 and an LC layer, e.g. VA mode liquid crystal, sandwiched between the two electrodes, wherein the upper transparent layer 91 is made of a whole piece of transparent electrode while the lower transparent layer 92 is composed of a plurality of parallel transparent electrodes respectively arranged associated with a plurality of pixel rows 83 included in the display unit 8 as shown in FIG. 2.

Please refer to FIGS. 1 to 4, FIG. 3 shows the control signal fed into the display unit 8 and the phase modulation unit 9, and FIG. 4 shows the polarization direction of the image signals at different image frames after being modulated by the phase modulation unit 9. In odd image frames (e.g. F₁, F₃ . . . ), a scan signal sequentially drives the plurality of pixel rows 83 of the display unit 8; meanwhile, a phase control signal drives the plurality of transparent electrodes of the lower transparent layer 92 of the phase modulation unit 9 corresponding to the scan signal driving the pixel rows 83. At this moment, the phase control signal provided to the phase modulation unit 9 can cause the image signals to have 180 degrees phase shift after passing through the phase modulation unit 9 during the odd image frames (e.g. image frame F₁ shown in FIG. 4). In even image frames (e.g. F₂, F₄ . . . ), the scan signal sequentially drives the plurality of pixel rows 83 of the display unit 8; meanwhile, a zero voltage is provided to the plurality of transparent electrodes of the lower transparent layer 92 of the phase modulation unit 9 corresponding to the scan signal driving the pixel rows 83. At this moment, since the driving voltage added on the phase modulation unit 9 is zero, the image signals has no phase shift after passing through the phase modulation unit 9 during the even image frames (e.g. image frame F₂ shown in FIG. 4).

In this way, the polarization directions of the image signals in odd image frames and even image frames are perpendicular to each other. The image signals having different polarization directions can be separated as left-eye image signals and right-eye image signals after passing through the perpendicularly polarized glasses. The left-eye image signals and right-eye image signals respectively enter the left eye and right eye of a user to show 3D images in the user's brain. However as shown in FIG. 2, because every transparent electrode of the lower transparent layer 92 must be accurately aligned with every pixel row 83 of the display unit 8 respectively in order to reduce the crosstalk between the image signals having different polarization directions, this alignment process can significantly increase the manufacturing complexity to increase the difficulty in mass production.

Accordingly, it is necessary to provide a 3D image display and driving method therefor that can reduce the crosstalk between image signals having different polarization directions and lower the manufacturing complexity.

### SUMMARY

It is an object of the present invention to provide a driving method for a 3D image display with reduced manufacturing complexity.

It is another object of the present invention to provide a driving method for a display that can reduce the crosstalk between image signals having different polarization directions.

The present invention provides a driving method for a display. The display includes a display unit and a phase modulation unit. The display unit further includes a plurality of pixel rows and is configured to generate image signals having a polarization direction. The phase modulation unit further includes two oppositely disposed electrodes and an LC layer sandwiched between the two electrodes. The driving method changes a potential difference provided on the two electrodes of the phase modulation unit to control the twist of the LC layer thereby changing the polarization direction of the image signals generated by the display unit and passing through the phase modulation unit.

In one embodiment, the driving method for a display includes the steps of: sequentially driving, with a first frequency, all the pixel rows of the display unit to successively generate image frames, wherein the image frames are generated alternatively a normal image frame and a black frame insertion; and alternatively providing, with a second frequency, a high potential difference within a high potential interval and a low potential difference within a low potential interval on the two electrodes of the phase modulation unit, wherein each the high potential interval and each the low potential interval synchronize to a time interval of one normal image frame and one black frame insertion.

In another embodiment, the driving method for a display includes the steps of:

sequentially driving, with a first frequency, all the pixel rows of the display unit to successively generate image frames, wherein the image frames are generated alternatively a normal image frame and a black frame insertion, and each the image frame comprises an LC response time; and alternatively providing, with a second frequency, a high potential difference within a high potential interval and a low potential difference within a low potential interval on the two electrodes of the phase modulation unit, wherein each the high potential interval and each the low potential interval synchronize to a time interval between start points of the LC response time of two successive black frame insertions.

The present invention further provides a driving method for a display. The display includes a display unit, a phase modulation unit and a black light. The display unit further includes a plurality of pixel rows and is configured to generate image signals having a polarization direction. The phase modulation unit further includes two oppositely disposed electrodes and an LC layer sandwiched between the two electrodes. The driving method includes the steps of: sequentially driving, with a first frequency, all the pixel rows of the display unit to successively generate image frames, wherein each the image frame comprises an LC response time and a backlight enable time;

alternatively providing, with the first frequency, a high potential difference within a high potential interval and a low potential difference within a low potential interval on the two electrodes of the phase modulation unit, wherein each the high potential interval and each the low potential interval synchronize to a time interval of one image frame; and providing, with the first frequency, a backlight control signal to enable the back light, wherein the backlight control signal synchronizes to the backlight enable time.

In the image display of the present invention, the two electrodes of the phase modulation unit are made of a whole piece of transparent electrode.

In the driving method for a display of the present invention, polarities of two successive high potential differences are opposite to each other such that the phase modulation unit may perform polarity inversion.

### BRIEF DESCRIPTION OF THE DRAWINGS

Other objects, advantages, and novel features of the present invention will become more apparent from the following detailed description when taken in conjunction with the accompanying drawings.

FIG. 1 shows a solid diagram of a conventional 3D image display.

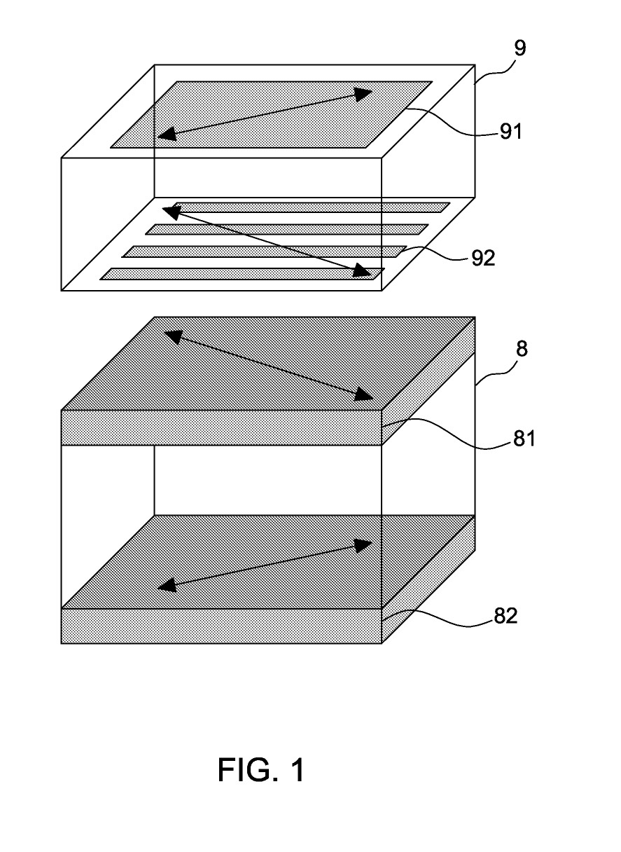

FIG. 2 shows a schematic diagram of the 3D image display shown in FIG. 1.

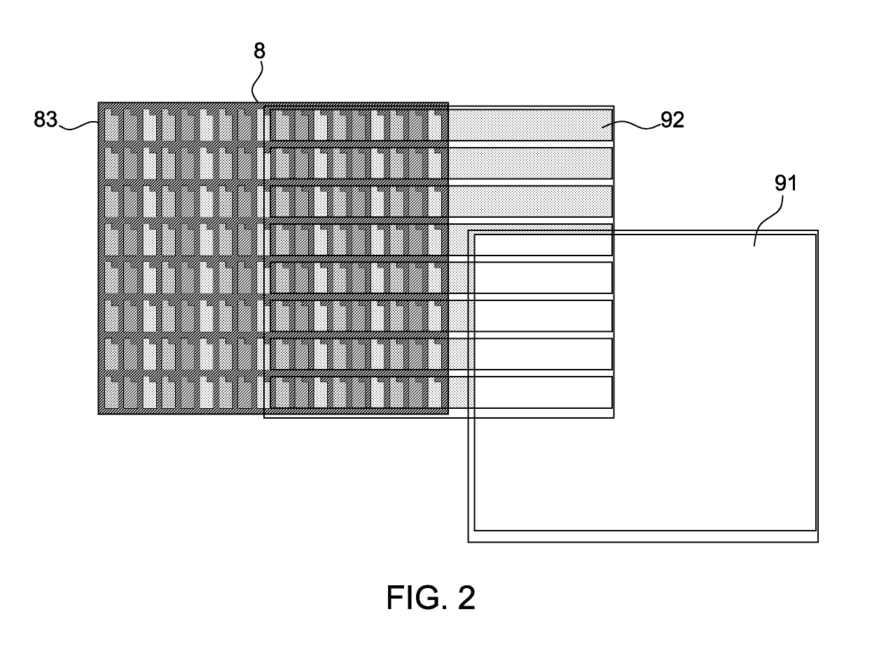

FIG. 3 shows a timing diagram of the control signal of the 3D image display shown in FIG. 1.

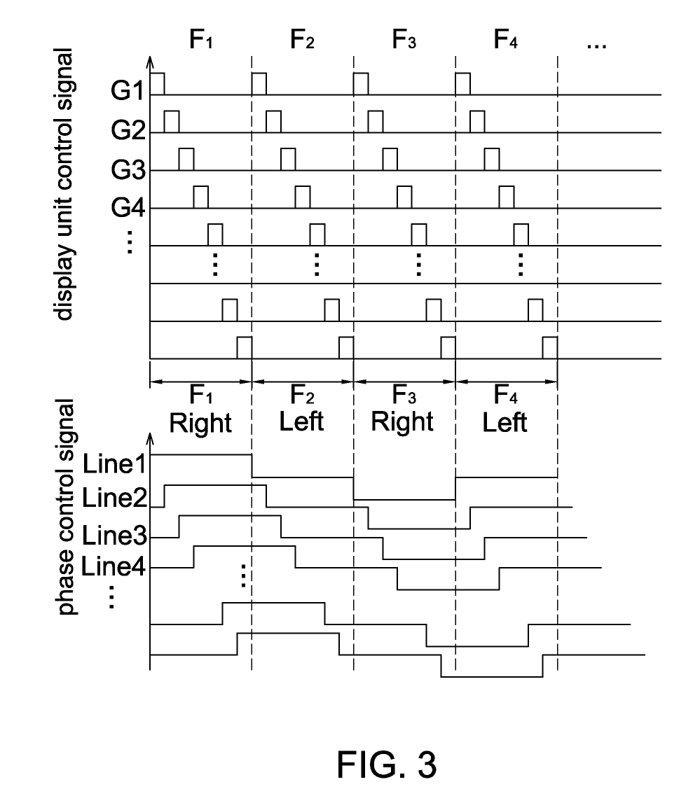

FIG. 4 shows a schematic diagram of the polarization direction of image signals generated by the conventional 3D image display according to the control signal shown in FIG. 3.

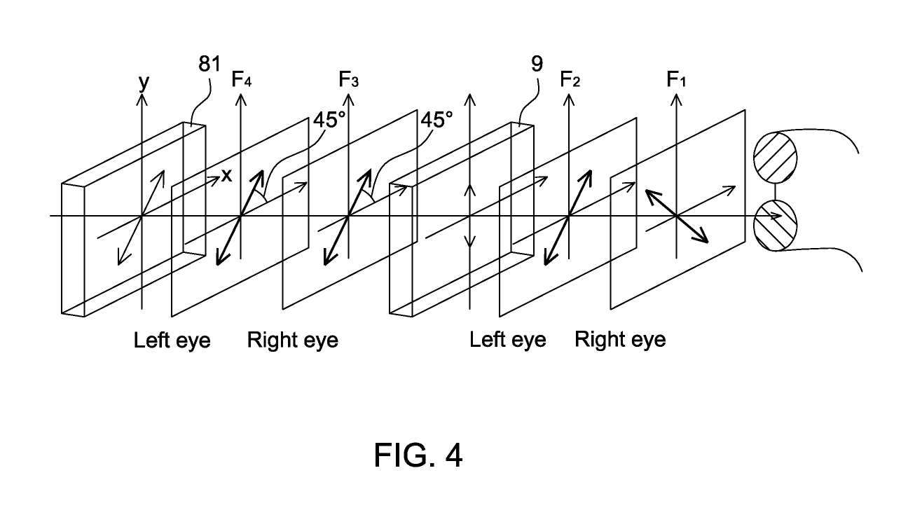

FIG. 5 shows a solid diagram of the 3D image display according to an embodiment of the present invention.

FIG. 6 shows a schematic diagram of the 3D image display shown in FIG. 5.

FIG. 7 shows an operational diagram of the driving method for a display according to the first embodiment of the present invention.

FIG. 8 shows an operational diagram of the driving method for a display according to the second embodiment of the present invention.

FIG. 9 shows an operational diagram of the driving method for a display according to the third embodiment of the present invention.

### DETAILED DESCRIPTION OF THE EMBODIMENT

It should be noted that, wherever possible, the same reference numbers will be used throughout the drawings to refer to the same or like parts.

In the drawings of the present invention, only a part of the components are shown and other components that are not directly related to the present invention are omitted.

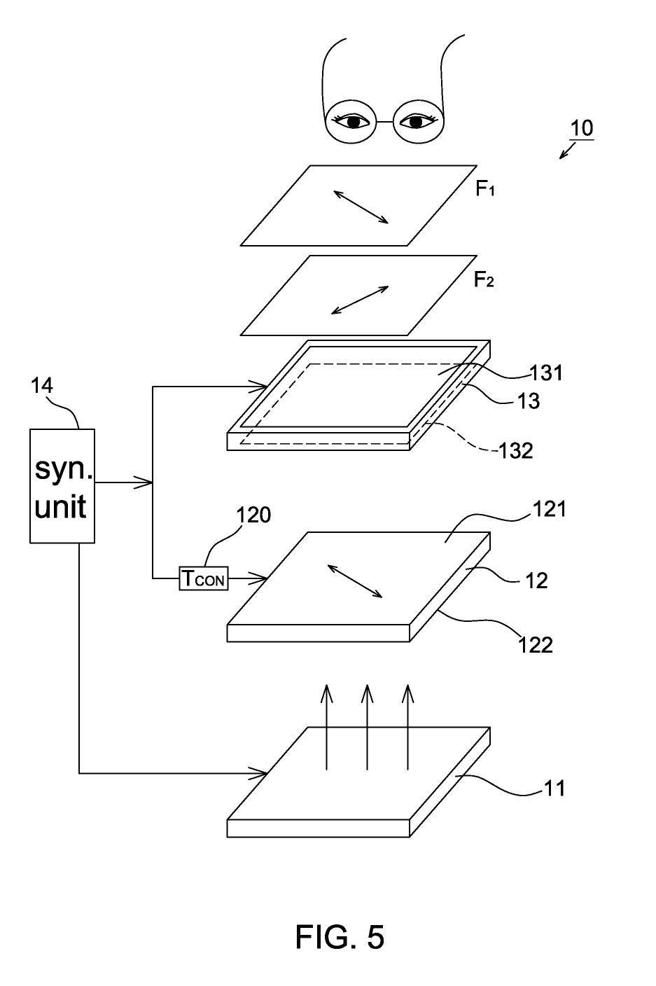

Please refer to FIG. 5, it shows a solid diagram of the 3D image display according to an embodiment of the present invention. Image display 10 includes a back light 11, a display unit 12, a timing controller 120, a phase modulation unit 13 and a synchronizing unit 14. The back light 11 is configured to provide light to the display unit 12 for displaying images, the back light 11 may be any back light module used in a conventional liquid crystal display (LCD), e.g. a cold cathode fluorescent lamp (CCFL) back light module, a light emitting diode (LED) back light module and etc., but not limited thereto. The display unit 12 may be a conventional LCD, which includes an upper polarizer 121, a lower polarizer 122 and a liquid crystal (LC) layer (not shown) sandwiched between the upper polarizer 121 and the lower polarizer 122. The display unit 12 generates image signals having a predetermined polarization direction through the upper polarizer 121. In other words, the back light 11 and the display unit 12 form a conventional LCD.

The phase modulation unit 13 includes an upper electrode 131, a lower electrode 132 and an LC layer (not shown), which may be twisted nematic (TN) mode, offset codebook (OCB) mode or valley alignment (VA) mode liquid crystal, sandwiched between the upper electrode 131 and the lower electrode 132. The upper electrode 131 and the lower electrode 132 are transparent electrodes formed of, for example, indium tin oxide (ITO), indium zinc oxide (IZO), indium oxide (IO), tin oxide (TO), zinc oxide (ZO), aluminum zinc oxide (AZO) and etc., but not limited thereto. The present invention utilizes the phase modulation unit 13 to modulate the predetermined polarization direction of the image signals generated by the display unit 12 and, through polarized glasses, two eyes of a user is able to respectively receive image signals having different polarization directions within different time intervals so as to see 3D images.

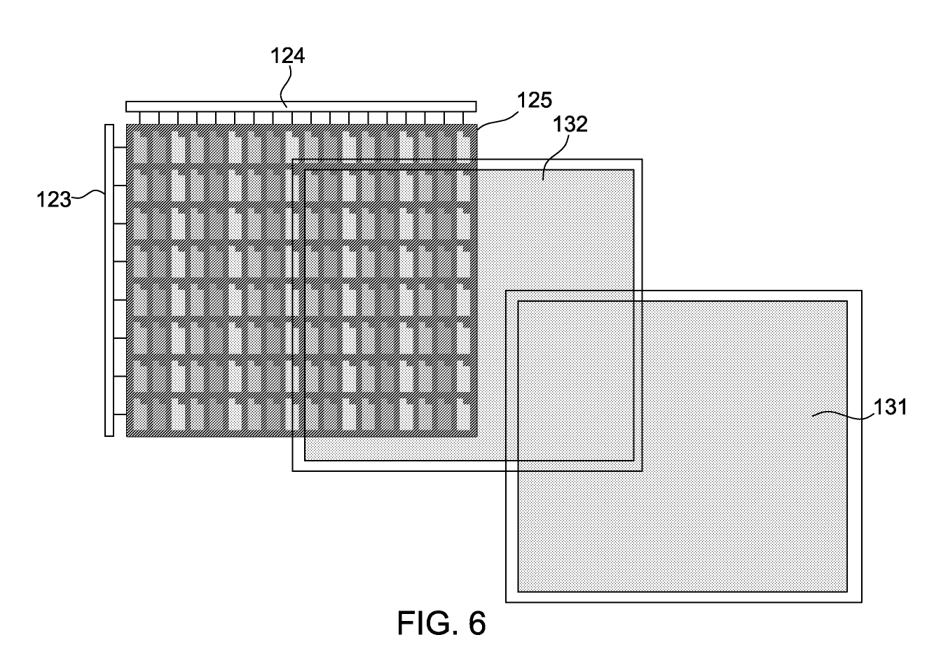

In the present invention, the upper electrode 131 (the one close to the user) is made of a whole piece of transparent electrode, and the lower electrode 132 (the one close to the display unit 12) is also made of a whole piece of transparent electrode, wherein an area of the lower electrode 132 preferably covers at least all pixel rows 125 included in the display unit 12 as shown in FIG. 6 so as to effectively modulate the image signals generated by the display unit 12. FIG. 6 is a schematic diagram of the 3D image display 10 shown in FIG. 5, wherein the upper electrode 131 and the lower electrode 132 are both made of a whole piece of transparent electrode. In the present invention, since the upper electrode 131 and the lower electrode 132 are both made of a whole piece of electrode, the alignment difficulty between the electrode of the phase modulation unit 13 and the plurality of pixel rows of the display unit 12 during manufacturing can be significantly released.

Please refer to FIGS. 5 and 6 again, the synchronizing unit 14 controls, through the timing controller 120, the display unit 12 to generate image signals in order to make the display unit 12 operate synchronizing to the phase modulation unit 13, and the control method thereof will be illustrated by embodiments hereinafter. The method that the timing controller 120 controls the display unit 12 to generate image signals is well known to the art, for example, the timing controller 120 may control a gate driver 123 to output a clock signal to sequentially drive every pixel row 125 within a frame interval and control a source driver 124 to output gray levels to be displayed to every column pixel within the frame interval. In addition, the timing controller 120 may also be integrated in the display unit 12 and is not limited to that shown in FIG. 5.

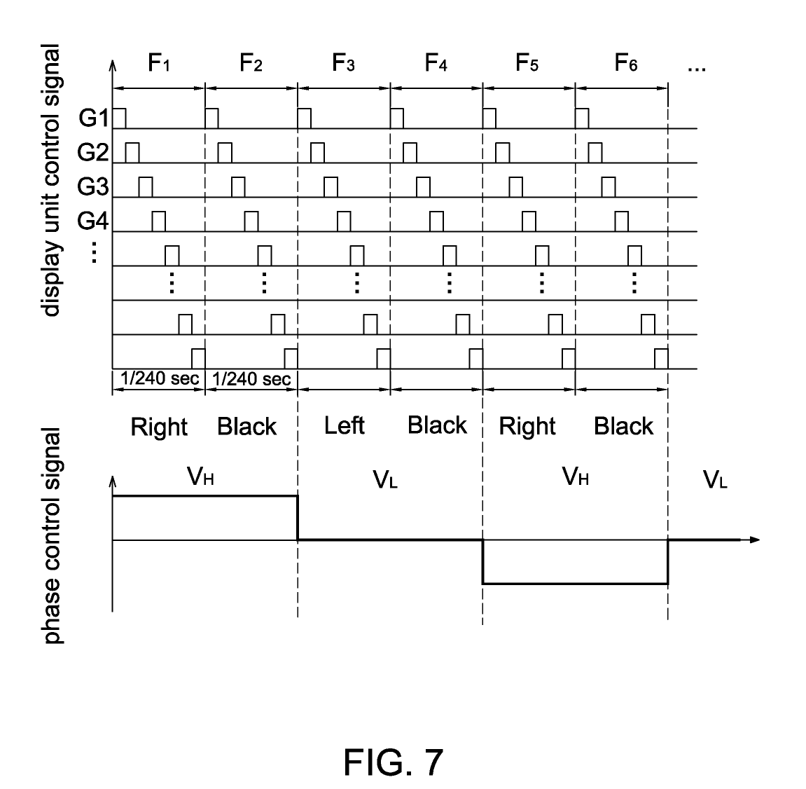

Please refer to FIGS. 5 to 7 together, FIG. 7 shows an operational diagram of the driving method for a display according to the first embodiment of the present invention. The timing controller 120 controls the gate driver 123 to output, for example with a frequency of 240 Hz, a clock signal to sequentially drive every pixel row 125 of the display unit 12 to successively generate image frames, e.g. F₁ to F₆. The timing controller 120 also controls the source driver 124 to output image data to be displayed to every pixel column in every frame interval, and to output a black data (i.e. zero gray level, L0) to all pixels after each normal image frame to form a black frame insertion, such that the crosstalk resulted from image signals having different polarization directions can be reduced. In this manner, the display unit 12 alternatively generates a normal image frame (F₁, F₃, F₅ . . . ) and a black frame insertion (F₂, F₄, F₆ . . . ) with a frequency of 240 Hz. The normal image frame herein refers to an image frame containing the image data to be seen by an observer.

During the operation of the display unit 12, the synchronizing unit 14 controls a phase control signal to be inputted to the phase modulation unit 13, for example a time-varying signal is inputted to one of the upper electrode 131 and the lower electrode 132, and the other electrode receives a fixed voltage such that a time-varying, e.g. 120 Hz, potential difference can be formed between the two electrodes. The phase control signal includes a high potential interval V_{H} corresponding to a high potential difference and a low potential interval V_{L} corresponding to a low potential difference, and the high potential difference and the low potential difference are alternatively provided to the two electrodes of the phase modulation unit 13, wherein a value of the potential difference within the high potential interval V_{H} is used to twist LC layer between the two electrodes to a predetermined position within a predetermined time interval and has no particular limitation. The potential difference within the low potential interval V_{L} may be substantially zero, but not limited thereto. In addition, polarities of the potential difference fed to the phase modulation unit 13 in two successive high potential intervals V_{H} are opposite to each other such that the voltage polarity provided on the LC layer between the two electrodes can be inverted. The synchronizing unit 14 controls the high potential interval V_{H} of the phase control signal and two successive image frames (including one normal image frame and a black frame insertion, e.g. F₁+F₂, F₅+F₆ . . . ) to synchronize; and controls the low potential interval V_{L} and other two successive image frames (including one normal image frame and a black frame insertion, e.g. F₃+F₄ . . . ) to synchronize.

In one embodiment, the LC layer sandwiched between the upper electrode 131 and the lower electrode 132 may be TN mode or OCB mode liquid crystal such that image signals do not have a phase shift within the high potential interval V_{H} and have substantially a 7E phase shift within the low potential interval V_{L}. In this manner, according to the driving signal shown in FIG. 7, the right eye of the user may receive, through polarized glasses, image signals having the same polarization direction with the image signals generated by the display unit 12 within the high potential interval V_{H} whereas the left eye of the user may receive, through polarized glasses, image signals having the polarization direction perpendicular to that of the image signals generated by the display unit 12 within the low potential interval V_{L}. As the image signals received by the left eye and the right eye are different, 3D images can be seen by the user. In another embodiment, the LC layer sandwiched between the upper electrode 131 and the lower electrode 132 may be VA mode liquid crystal such that image signals have substantially a π phase shift within the high potential interval V_{H} and do not have a phase shift within the low potential interval V_{L}. No matter what is the LC layer between the two electrodes, two eyes of the user may respectively receive the image signals having different polarization directions through polarized glasses. As the image signals receive by the left eye and the right eye are different, 3D images can be seen by the user. It is appreciated that the polarization directions of the image signals received by the left eye and the right eye mentioned above are only exemplary and the present invention is not limited thereto. In addition, the generated frequency of the image signals and the frequency of the phase control signal are only exemplary and the present invention is not limited thereto.

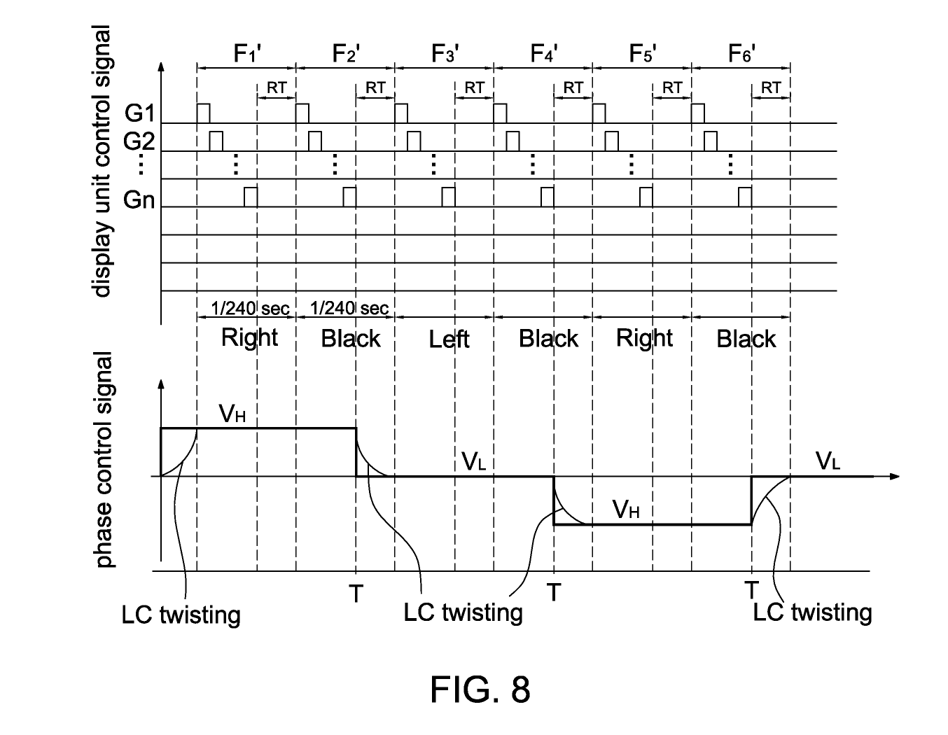

Please refer to FIGS. 5, 6 and 8 together, FIG. 8 shows an operational diagram of the driving method for a display according to the second embodiment of the present invention. The timing controller 120 controls the gate driver 123 to output, for example with a frequency of 240 Hz, a clock signal to sequentially drive every pixel row 125 of the display unit 12 to successively generate image frames, e.g. F₁′ to F₆′. However, as the LC layer of the display unit 12 needs more response time RT to twist to the predetermined position, in this embodiment within every frame interval, when the last pixel row of the display unit 12 is driven, an additional LC response time RT is preserved such that all LC molecules can twist to the predetermined position before the next image frame is inputted, i.e. no pixel row is driven by the clock signal within the LC response time RT. In one embodiment, the LC response time RT may be implemented by controlling the gate driver 123 to drive a plurality of fictional pixel rows that do not exist in reality. In addition, the timing controller 120 controls the source driver 124 to output image data to be displayed to every pixel column in every frame interval, and outputs a black data (i.e. zero gray level, L0) to all s after each normal image frame to form a black frame insertion, and the black frame insertion also includes an LC response time RT. In this manner, the display unit 12 alternatively generates a normal image frame (F₁′, F₃′, F₅′ . . . ) and a black frame insertion (F₂′, F₄′, F₆′ . . . ) with a frequency of 240 Hz, and every frame interval includes an LC response time RT.

During the operation of the display unit 12, the synchronizing unit 14 controls a phase control signal to be inputted to the phase modulation unit 13, for example a time-varying signal is inputted to one of the upper electrode 131 and the lower electrode 132, and the other electrode receives a fixed voltage such that a time-varying, e.g. 120 Hz, potential difference can be formed between the two electrodes. The phase control signal includes a high potential interval V_{H} and a low potential interval V_{L}, and the high potential difference and the low potential difference are alternatively provided to the two electrodes of the phase modulation unit 13, wherein a value of the potential difference within the high potential interval V_{H} and the low potential interval V_{L} may be set similar to the first embodiment. In this embodiment, the synchronizing unit 14 controls the high potential interval V_{H} and the low potential interval V_{L} of the phase control signal to synchronize to a time interval between start points T of the LC response time RT of two successive black frame insertions. In addition, the LC response time RT of the display unit 12 in the black frame insertion is substantially synchronized to the LC response time of the phase modulation unit 12 such that left-eye image signals and right-eye image signals are generated after the twisting of liquid crystal molecules of the phase modulation unit 13 is accomplished such that no image signal will be generated during the twisting of liquid crystal molecules. It is appreciated that, an actual value of the LC response time RT may be determined according to the LC layer actually being used, e.g. the LC response time RT may be at least 3 ms.

In this embodiment, no matter what is the LC layer between the two electrodes, two eyes of the user may respectively receive the image signals having different polarization directions through polarized glasses. In addition, the generated frequency of the image signals and the frequency of the phase control signal are only exemplary and the present invention is not limited thereto.

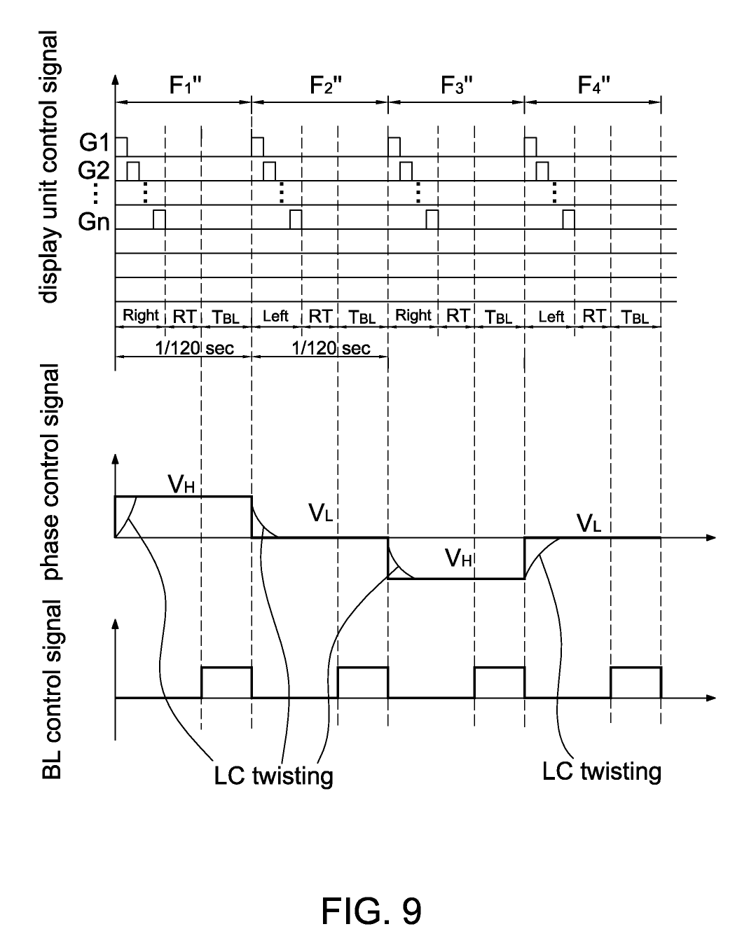

Please refer to FIGS. 5, 6 and 9 together, FIG. 9 shows an operational diagram of the driving method for a display according to the third embodiment of the present invention. The timing controller 120 controls the gate driver 123 to output, for example with a frequency of 120 Hz, a clock signal to sequentially drive every pixel row 125 of the display unit 12 to successively generate image frames, e.g. F₁″ to F₄″. In this embodiment, in addition to the LC response time RT that the LC layer of the display unit 12 takes to twist to the predetermined position is preserved within every frame interval, an additional backlight enable time T_{BL} is further preserved. In other words, in this embodiment each frame interval includes an enable time for driving every pixel row, an LC response time RT and a backlight enable time T_{BL}, and no pixel row is driven by the clock signal within the LC response time RT and the backlight enable time T_{BL}. The LC response time RT and the backlight enable time T_{BL} may also be implemented by controlling the gate driver 123 to drive a plurality of fictional pixel rows that do not exist in reality, wherein the backlight enable time T_{BL} is a last time interval in every image frame, and the LC response time RT is wrote in every image frame between a time interval of the last pixel row being driven and a time interval of the backlight enable time T_{BL} as shown in FIG. 9.

During the operation of the display unit 12, the synchronizing unit 14 controls a phase control signal to be inputted to the phase modulation unit 13, for example a time-varying signal is inputted to one of the upper electrode 131 and the lower electrode 132, and the other electrode receives a fixed voltage such that a time-varying, e.g. 120 Hz, potential difference can be formed between the two electrodes. The phase control signal includes a high potential interval V_{H} and a low potential interval V_{L}, and the high potential difference and the low potential difference are alternatively provided to the two electrodes of the phase modulation unit 13, wherein a value of the potential difference within the high potential interval V_{H} and the low potential interval V_{L} may be set similar to the first embodiment. In this embodiment, the synchronizing unit 14 controls the high potential interval V_{H} and the low potential interval V_{L} of the phase control signal to synchronize to every frame interval of the display unit 12.

During the operation of the display unit 12 and the phase modulation unit 13, the synchronizing unit 14 further controls a backlight control signal to be inputted to the back light 11 and controls the enable time of the back light 11 to synchronize to the backlight enable time T_{BL} of the display unit 12. Since all pixel rows have been driven by the clock signal and liquid crystal molecules have been twisted to the predetermined position within enough LC response time RT before the back light 11 turns on (i.e. T_{BL}), two eyes of the user will not receive the image signals during the liquid crystal molecules in twisting. It is appreciated that an actual value of the LC response time RT may be determined according to the LC layer actually being used, e.g. at least 3 ms. The backlight enable time T_{BL} may be controlled by the synchronizing unit 14. Because the working frequency of the display unit 12 is 120 Hz in this embodiment, a total sum of an enable time of driving all pixel rows, an LC response time RT and a backlight enable time T_{BL} is 1/120 ms (8.33 ms). If the enable time of driving all pixel rows and/or the LC response time RT is reduced, the backlight enable time T_{BL} can be increased to enhance the brightness efficiency of the display unit 12.

In this embodiment, no matter what is the LC layer between the two electrodes, two eyes of the user may respectively receive the image signals having different polarization directions through polarized glasses. Compared to the first and second embodiments, the timing controller 120 of the third embodiment drives all pixel rows with a lower frequency (e.g. 120 Hz) so as to reduce the control loading of the timing controller 120. In addition, the generated frequency of the image signals and the frequency of the phase control signal are only exemplary and the present invention is not limited thereto.

It is appreciated that, although right-eye image signals are previous to left-eye image signals as shown in FIGS. 7 to 9, they are only exemplary and the left-eye image signals may be previous to the right-eye image signals in other embodiments.

As mentioned above, as conventional 3D image displays need accurate alignment during manufacturing such that they have the problem of increased manufacturing complexity. The present invention further provides a driving method for a display that can be applied to an image display without the need of accurate alignment during manufacturing. The driving method of the present invention further has the effect of being able to reduce the crosstalk between image signals having different polarization directions.

Although the invention has been explained in relation to its preferred embodiment, it is not used to limit the invention. It is to be understood that many other possible modifications and variations can be made by those skilled in the art without departing from the spirit and scope of the invention as hereinafter claimed.

What is claimed is:

1. A driving method for a display, the display comprising a display unit, a phase modulation unit and a black light, the display unit further comprising a plurality of pixel rows and generating image signals having a polarization direction, the phase modulation unit further comprising two oppositely disposed electrodes and a liquid crystal layer sandwiched between the two electrodes, the driving method comprising:
sequentially driving, with a first frequency, all the pixel rows of the display unit to successively generate image frames, wherein each the image frame comprises a liquid crystal response time and a backlight enable time;
alternatively providing, with the first frequency, a high potential difference within a high potential interval and a low potential difference within a low potential interval on the two electrodes of the phase modulation unit, wherein each the high potential interval and each the low potential interval synchronize to a time interval of one image frame; and
providing, with the first frequency, a backlight control signal to enable the back light, wherein the backlight control signal synchronizes to the backlight enable time.

2. The driving method as claimed in claim 1, wherein the first frequency is 120 Hz.

3. The driving method as claimed in claim 1, wherein the backlight enable time is a last time interval in every image frame; and the liquid crystal response time is wrote in every image frame between a time interval of a last pixel row being driven and a time interval of the backlight enable time.

4. The driving method as claimed in claim 1, wherein the two electrodes of the phase modulation unit are respectively made of a whole piece of transparent electrode.

5. The driving method as claimed in claim 1, wherein after passing through the phase modulation unit, the polarization direction of the image signals associated with the high potential interval is perpendicular to that associated with the low potential interval, and polarities of two successive high potential differences are opposite to each other.
